(19) United States
(12) Patent Application Publication
(10) Pub. No.: US 2007/0260497 A1
(43) Pub. Date: Nov. 8, 2007

(54) Method of planning train movement using a front end cost function

(76) Inventors: Wolfgang Daum, Erie, PA (US); Randall Markley, Melbourne, FL (US); Paul Julich, Indialantic, FL (US); Mitchell Scott Wills, Melbourne, FL (US); John Hershey, Ballston Lake, NY (US)

Correspondence Address: DUANE MORRIS LLP, Suite 700, 1667 K Street, N.W., Washington, DC, 20006, US

(21) Appl. No.: 11/415,273

(22) Filed: May 2, 2006

(51) Int. Cl. G06F 17/50

(52) U.S. Cl. 705/7

(57) ABSTRACT

A method of optimizing the movement of plural trains using a front end cost function that evaluates the costs of each railcar in the consist of a train.

### BACKGROUND OF THE INVENTION

The present invention relates to the scheduling of movement of plural units through a complex movement defining system, and in the embodiment disclosed, to the scheduling of the movement of freight trains over a railroad system using a front end cost function.

Systems and methods for scheduling the movement of trains over a rail network have been described in U.S. Pat. Nos. 6,154,735, 5,794,172, and 5,623,413, the disclosure of which is hereby incorporated by reference.

As disclosed in the referenced patents and applications, the complete disclosure of which is hereby incorporated herein by reference, railroads consist of three primary components (1) a rail infrastructure, including track, switches, a communications system and a control system; (2) rolling stock, including locomotives and cars; and, (3) personnel (or crew) that operate and maintain the railway. Generally, each of these components are employed by the use of a high level schedule which assigns people, locomotives, and cars to the various sections of track and allows them to move over that track in a manner that avoids collisions and permits the railway system to deliver goods to various destinations.

As disclosed in the referenced patents and applications, a precision control system includes the use of an optimizing scheduler that will schedule all aspects of the rail system, taking into account the laws of physics, the policies of the railroad, the work rules of the personnel, the actual contractual terms of the contracts to the various customers and any boundary conditions or constraints which govern the possible solution or schedule such as passenger traffic, hours of operation of some of the facilities, track maintenance, work rules, etc. The combination of boundary conditions together with a figure of merit for each activity will result in a schedule which maximizes some figure of merit such as overall system cost.

As disclosed in the referenced patents and applications, and upon determining a schedule, a movement plan may be created using the very fine grain structure necessary to actually control the movement of the train. Such fine grain structure may include assignment of personnel by name, as well as the assignment of specific locomotives by number, and may include the determination of the precise time or distance over time for the movement of the trains across the rail network and all the details of train handling, power levels, curves, grades, track topography, wind and weather conditions. This movement plan may be used to guide the manual dispatching of trains and controlling of track forces, or may be provided to the locomotives so that it can be implemented by the engineer or automatically by switchable actuation on the locomotive.

The planning system is hierarchical in nature in which the problem is abstracted to a relatively high level for the initial optimization process, and then the resulting course solution is mapped to a less abstract lower level for further optimization. Statistical processing is used at all levels to minimize the total computational load, making the overall process computationally feasible to implement. An expert system is used as a manager over these processes, and the expert system is also the tool by which various boundary conditions and constraints for the solution set are established. The use of an expert system in this capacity permits the user to supply the rules to be placed in the solution process.

Currently, railroad operations are scheduled to meet various optimization criteria. One very important criterion is cost. Typically, costs associated with railroad operations are static, coarse-grained, and of low dimension. They are static in the sense that the cost function is not amenable to change as overall transportation conditions change or as exigencies emerge. They are coarse-grained in that they generally respect and are computed on consists as a whole or on whole orders and not their consistent parts. They are of low dimension in that they are computed on a single parameter such as promised delivery time. There is presently a need for more detailed and dynamic costing in order to approach and effect optimization protocols that will provide enhanced utility to the carriers.

The current disclosure provides a costing function, protocol, and process that will better serve the needs of the modern rail transportation business. A costing function produces an output of cost. Cost, by its nature, is a singly-dimensional item that is, in reality, a function of a plurality of inputs reflecting the multi-dimensional nature of the situation. The costing function described in the present disclosure is based on a plurality of inputs and subsequent operations on those inputs that will more clearly and meaningfully create a costing output. The costing is fine-grained in that it is evaluated over all revenue-generating cars. In one embodiment, the costing output may be a real-time output. In another embodiment, the costing function may be a prediction.

These and many other objects and advantages of the present invention will be readily apparent to one skilled in the art to which the invention pertains from a perusal of the claims, the appended drawings, and the following detailed description of the embodiments.

### BRIEF DESCRIPTION OF THE DRAWINGS

FIG. 1 is a simplified pictorial representation of a consist repaired and reformed in a hump yard using one embodiment of the fine grained costing function.

FIG. 2 is a simplified pictorial representation of the inputs to one embodiment of a costing function.

### DETAILED DESCRIPTION

A “consist” is a one or more power units combined with a set of cars. The total cost of a railroad shipment is a function of the individual or fine-grained costs of the distinct conveyance elements of the shipment carrier. For a consist the distinct conveyance elements would include the load carrying cars, the total shipment being partitioned over the cars in the consist. The total cost of a consist can vary over time during the movement of the train. For example, if some of the cars are delayed in arrival relative to others, then the cost incurred may be a function of penalties assessed against the shipment as a whole or as penalties proportioned according to the number of distinct conveyance elements arriving in a timely manner. The typical prior art optimizer attempts to plan the movement of the train to minimize the cost, and the present disclosure is an improvement of the costing function that can be used with prior art movement planners

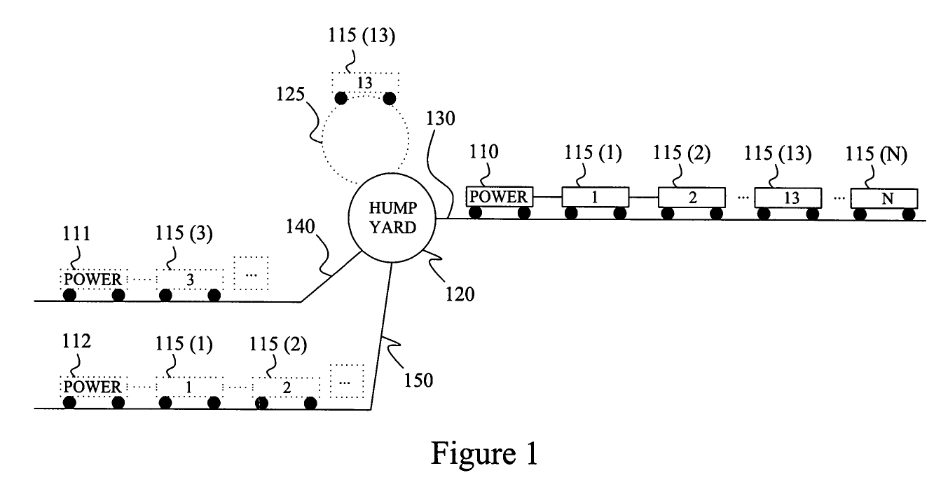

FIG. 1 illustrates a consist composed of a power unit 110 pulling cars 115(1)-115(n), that enters a hump yard 120 on track 130. In the hump yard 120 the consist is decomposed into its constituent parts consisting of the power unit and the individual conveyance elements or cars. The power units and cars are formed into new consists in order to help move the shipments to their ultimate destinations as depicted by the outgoing consists on tracks 140 and 150. The incoming and outgoing consists are inspected in the hump yard and if a defect in a car is found, the car is set aside or “bad-ordered” and repair is required before the car may again travel on the railroad system outside of the hump yard. In FIG. 1, car 115(13) is depicted as bad-ordered and has been placed on a repair track 125. If the repair indicated for car 115(13) is substantial, the car may be delayed beyond the time that other cars carrying a portion of a shipment that arrived with car 115(13) leave the hump yard. Thus, the conveyance elements for a particular shipment are then physically de-linked and must be tracked and assessed separately to reflect that car 115(13) is no longer in a consist leaving the hump yard, and that car 115(3) is no longer in the same consist with cars 115(1) and 115(2).

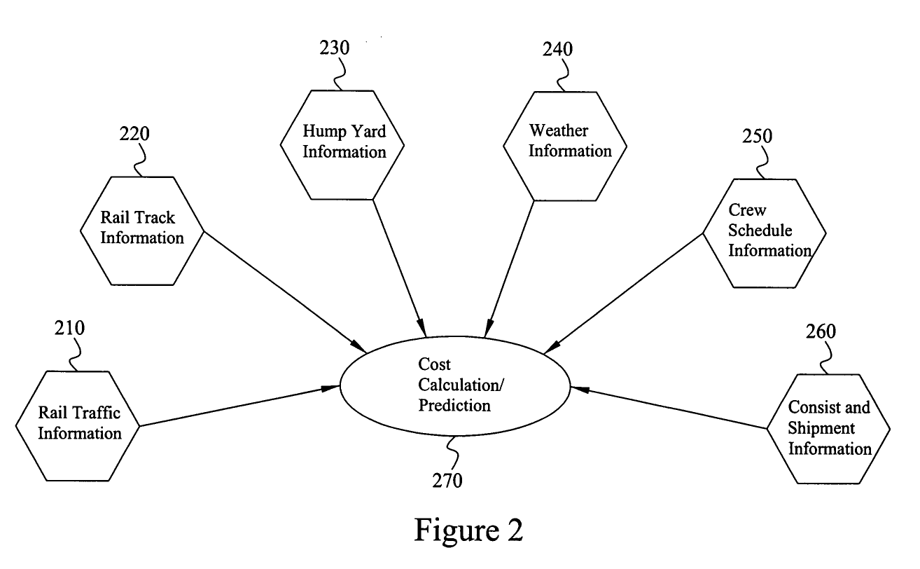

The total cost of a railroad shipment is also a function of many other items, some static and some time-varying or dynamic. FIG. 2 illustrates one embodiment of the costing function 270 showing various inputs that may be used to determine the costs associated with each conveyance element. The consist and shipment information 260 is necessary in order to know the initial spatial disposition, i.e., start and end points, of the transported goods and their contractual delivery terms. Rail traffic information 210 and rail track information 220 are essential in evaluating the available routes to gauge potential delays. Delays may affect penalties or incentives, and may prompt rerouting of a train. Hump yard information 230 is necessary to assess delays through the yard. The hump yard information 230 may be provided by a centralized information system as received from devices such as automatic equipment identifiers (AEI), on-car sensor systems or telemeters. Weather information 240 and crew schedule information 250 is also useful to gauge potential delays.

The cost calculation or cost prediction 270 may be any multi-input function that maps the plurality of inputs to a cost. Such functions may include, but are not necessarily limited to, mathematically convex functions of the weighted parameters and extrapolation techniques in combination with filtering techniques to estimate future delays and their monetary impact. The weighted parameters may include expected time of delivery of individual cars, late delivery penalties, crew overtime rates, effects on other consists, etc. In another embodiment, the cost functions may also be non-linear forms or be expressible as neural networks or other functional heuristics.

While embodiments of the present invention have been described, it is understood that the embodiments described are illustrative only and the scope of the invention is to be defined solely by the appended claims when accorded a full range of equivalence, many variations and modifications naturally occurring to those of skill in the art from a perusal hereof.

What is claimed:

1. A method of optimizing the movement of plural trains over a rail network, each train having plural railcars, comprising:
(a) evaluating the costs associated with the movement of each rail car;
(b) planning the movement of the train as a function of the evaluated costs of each rail car;
(c) monitoring the actual movement of the train;
(d) re-evaluating the costs associated with each rail car as a function of the monitored movement of the train; and
(e) modifying the planned movement of the trains as a function of the re-evaluated costs of the railcars.

2. The method of claim 1 wherein the step of planning the movement of the trains includes combining the evaluated costs of each rail car to determine a total cost for each train.

3. The method of claim 1 wherein the step of evaluating the costs includes an evaluation of hump yard information.

4. The method of claim 1 wherein the step of evaluating the costs includes an evaluation of the location of a railcar.
